(19) United States
(12) Patent Application Publication
(10) Pub. No.: US 2005/0254934 A1
(43) Pub. Date: Nov. 17, 2005

(54) Lifting forks

(76) Inventors: John Blades, West Midlands (GB); Stanley John Walker, Hampshire (GB)

Correspondence Address: SMITH-HILL AND BEDELL, P.C., 16100 NW CORNELL ROAD, SUITE 220, BEAVERTON, OR, 97006, US

(21) Appl. No.: 11/115,599

(22) Filed: Apr. 26, 2005

(30) Foreign Application Priority Data
May 11, 2004 (GB) 0410414.7

(51) Int. Cl. B65G 1/00

(52) U.S. Cl. 414/723

(57) ABSTRACT

An arrangement for supporting lifting hooks for a mechanical handling device is described. Forks (not shown) are hooked over a rail 42 and extend down to rest against a lower bar 40. For each fork 20, the hook is located between the plates 48 or the plates 54, which form two carriages 46A, 46B. These can slide along the rail 42, drawing the forks with them. Movement of the carriages 46A, 46B is coordinated by racks 62A, 62B which extend from respective carriages 46A, 46B and mesh with a pinion wheel 64. Thus, the forks can be maintained symmetrically disposed about the centre line of the lifting apparatus, thereby improving safety of operation.

The present invention relates to lifting forks of mechanical lifting apparatus.

Various types of mechanical lifting apparatus use lifting forks, for example for use in lifting pallets of goods. Examples include fork trucks and diggers with interchangeable tools etc.

The present invention provides an arrangement for controlling lifting forks in a mechanical lifting apparatus, comprising a slide arrangement on which the forks are supported, during use, and along which the forks may slide toward or away from each other, control members operable to move respective forks along the slide arrangement, and linkage means operable between the control members to cause the movement of the control members to be coordinated in a predetermined fashion.

The linkage means preferably causes the control members to move in opposite directions. The linkage means may cause the control members to remain symmetrically disposed about a fixed position. The fixed position is preferably on the centre line of the lifting apparatus.

The linkage means may include toothed members which move as the control members move, and which mesh with a common rotatable member to provide coordination in the movement of the toothed members and thereby of the control members. The toothed members may be racks which mesh with a common pinion wheel. Drive means may be provided to drive the common pinion wheel, thereby providing coordinated driven movement of the control members.

The linkage means may include at least one elongate flexible member connected at its ends to respective control members, and at least one pulley arrangement cooperating with the flexible member, so that when one of the control members is moved in at least one direction, the flexible member is caused to pull the other control member, to coordinate movement.

An actuator is preferably provided, operable to drive one of the control members.

Each control member may include two surfaces between which the respective fork is captive to move as the control member moves.

Examples of the present invention will now be described in more detail, by way of example only, and with reference to the accompanying drawings, in which:

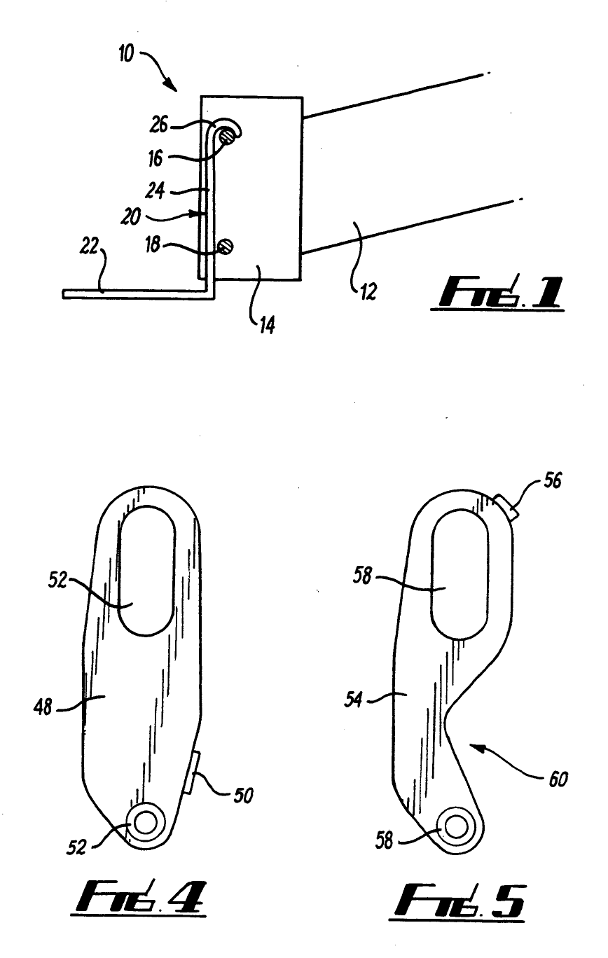

FIG. 1 is a simple schematic side view of a previous lifting apparatus arrangement;

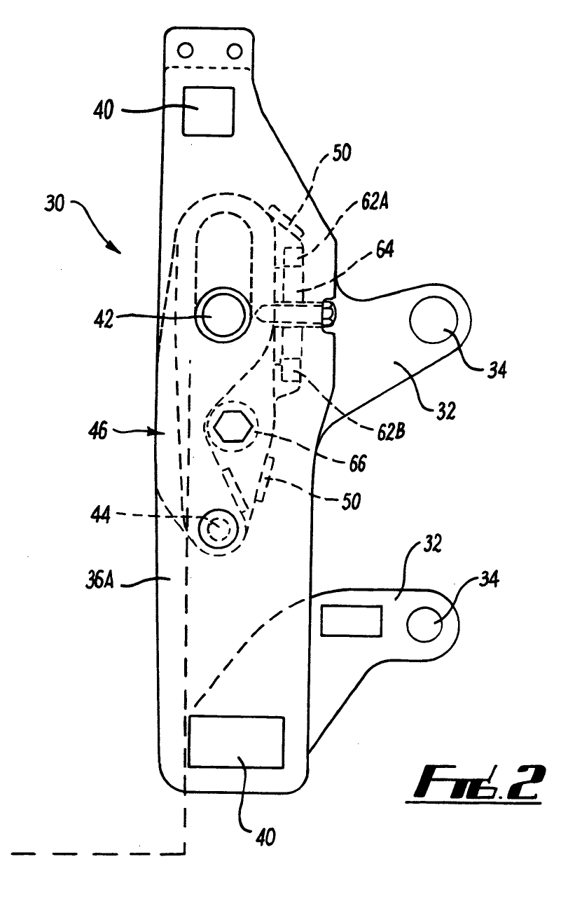

FIGS. 2 and 3 are side and front elevations of an arrangement according to the present invention;

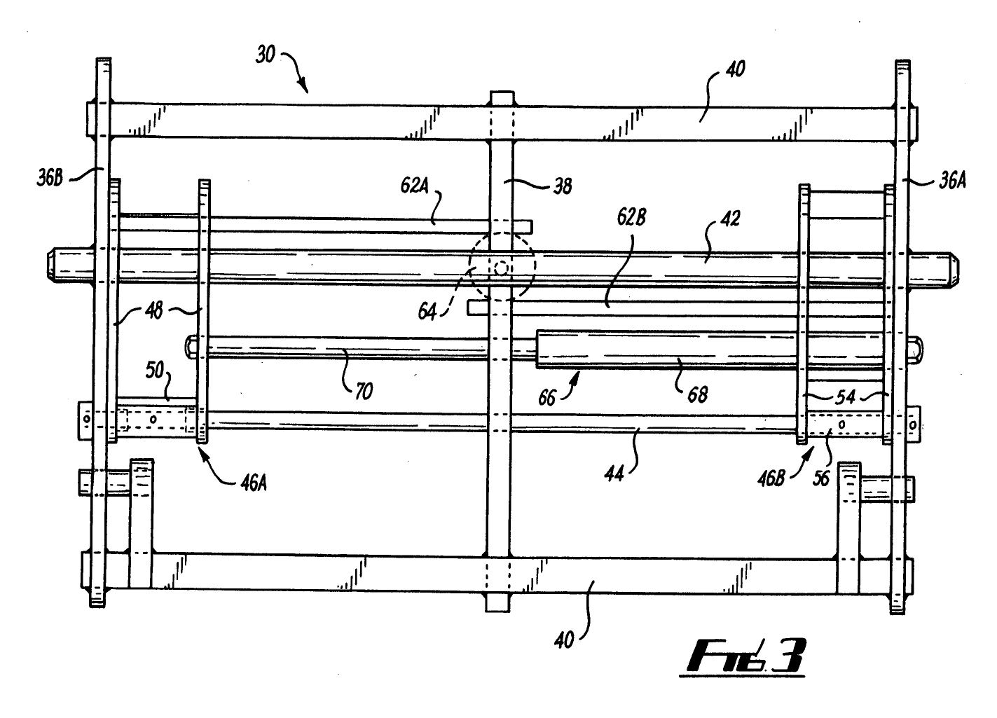

FIGS. 4 and 5 are side elevations of carriage plates of the arrangement of FIGS. 2 and 3;

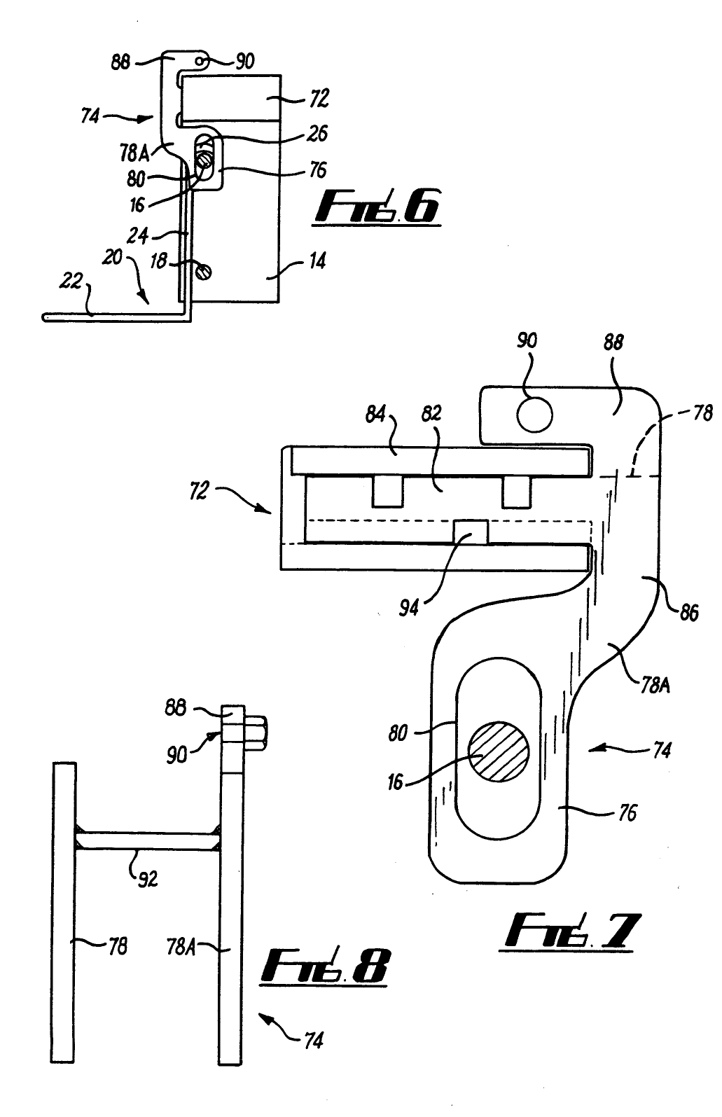

FIG. 6 corresponds with FIG. 1, showing an alternative arrangement in accordance with the invention;

FIG. 7 is a partial and partially cut away view of the arrangement of FIG. 6, viewed in the opposite direction;

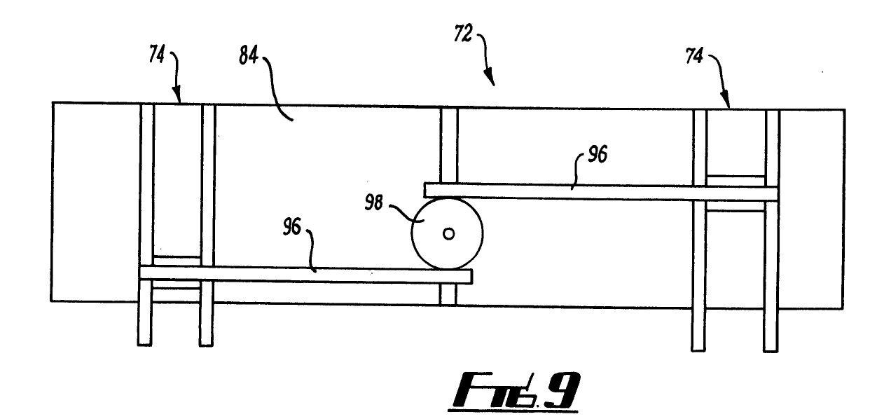

FIG. 8 is a front view of one carriage of the arrangement of FIGS. 6 and 7;

FIG. 9 is a plan view within the housing of the arrangement of FIGS. 6 and 7;

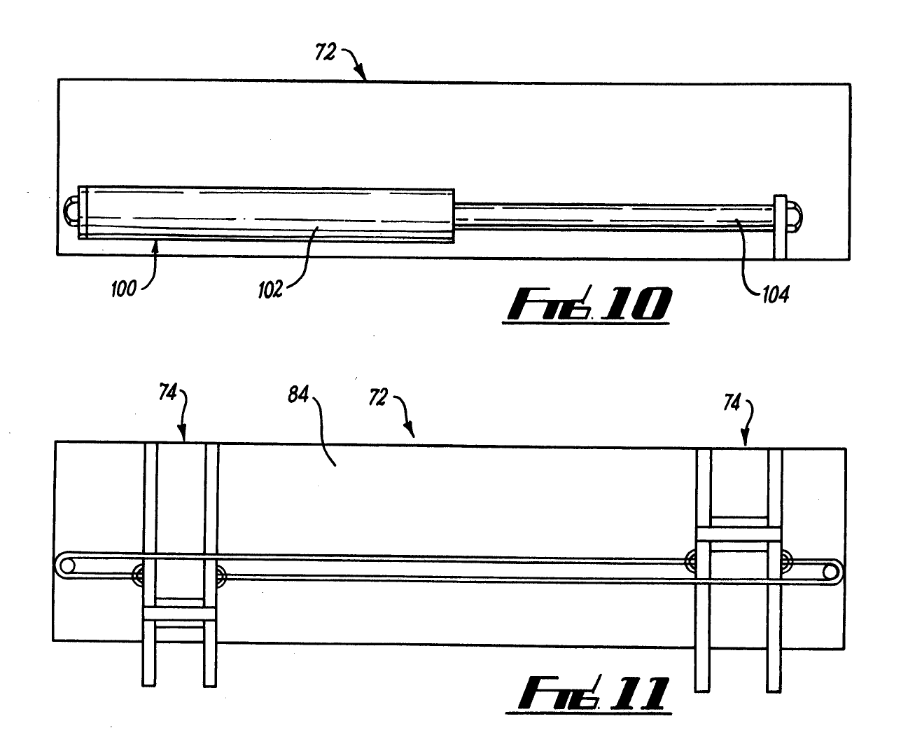

FIG. 10 is a top view of the arrangement of FIGS. 6 and 7; and

FIG. 11 corresponds with FIG. 9, showing an alternative arrangement for coordinating.

FIG. 1 shows a previous proposal for providing lifting forks in a mechanical lifting apparatus. In this example, lifting apparatus indicated generally at 10 has an arm 12 which can be raised or lowered and carries, at its free end, a standard coupling 14, for interchangeable attachment of accessories. The coupling 14 includes upper and lower bars 16, 18.

A lifting fork 20 has a generally horizontal tine 22 and a generally upright shank 24 which finishes in a hook formation 26. The dimensions of the fork 20 are such that the hook 26 can be hooked over the upper bar 16, so that the shank 24 then extends down to rest against the lower bar 18, thus allowing the tine 22 to support a load.

In this previous proposal, two forks 20, generally as shown in FIG. 1, are coupled to the coupling 14 at an appropriate separation to allow a pallet or other load to be lifted. This may require the driver to leave the controls of the machine, in order to adjust the separation of the forks 20, particularly when changing between loads of different dimensions. This takes time and, if the forks 20 are not correctly positioned, may be dangerous. In particular, it is relatively easy to position the forks 20 so that the load is carried off-centre by the apparatus 10.

FIGS. 2 to 5 show a first arrangement according to the present invention. This is in the form of a module 30 which has upper and lower rearward limbs 32 having eyes 34 to allow the limbs 32 to be fitted around the bars 16, 18 of the apparatus 10, thereby mounting the module 30 on the apparatus 10.

The module 30 is in the form of a frame having side plates 36A, 36B, a centre plate 38 and upper and lower connecting bars 40. The bars 40 extend between the side plates 36A, 36B and are attached to the side plates 36A, 36B and to the centre plate 38. Upper and lower rails 42, 44 are also attached to the side plates 36A, 36B and the centre plate 38.

The rails 42, 44 provide a track for control members in the form of two carriages 46A, 46B. The carriage 46A is formed of two parallel plates 48, spaced along the rails 42, 44 and connected together by relatively short bars 50. The profile of the plates 48 is shown in FIG. 4. Eyes 52 provide a sliding fit over the rails 42, 44. Thus, with the plates 48 parallel and perpendicular to the rails 42, 44, the carriage 46A can slide in either direction along the rails 42, 44.

Similarly, the carriage 46B is formed from two plates 54, connected at 56 and having a profile shown in FIG. 5, including eyes 58 for receiving the rails 42, 44, so that the carriage 46B is also slidable along the rails 42, 44, as has been described.

The profile of the plates 48, 54 is very similar, as can be seen from FIGS. 4 and 5, except for an additional cut-away region 60 in the plates 54B, but not provided in the plates 48. The purpose for this will become apparent below.

The carriages 46A, 46B each carry a straight, horizontal rack 62A, 62B (FIG. 3). The rack 62A is above the rail 42; the rack 62B is below the rail 42. The racks 62A, 62B extend from the respective carriages 46A, 46B toward, and past the centre plate 38, even when the carriages 46A, 46B are at their extreme positions away from the plate 38, abutting the side plates 36A, 36B. The centre plate 38 provides a mounting for a pinion wheel 64 which meshes with the rack 62A above and with the rack 62B below.

Accordingly, movement of the carriages 46A, 46B is coordinated by the rack and pinion arrangement, because movement of one rack 62, such as to turn the pinion 64, requires movement of the other rack 62 to occur.

A hydraulic actuator 66 has a cylinder 68 mounted on the side plate 36B and extends generally parallel with the rails 42, 44 past the carriage 46B toward the carriage 46A. The shaft 70 of the actuator 66 is fixed to the carriage 46A. The cut-away 60 in the plates 54B of the carriage 46B provide clearance between the carriage 46B and the cylinder 68.

The actuator 66 is a double acting cylinder which can therefore be pressurised in either sense to pull the carriage 46A toward the cylinder 68, or to push the carriage 46A away from the cylinder 68. As this movement occurs, the rack 62A moves with the carriage 46A causing the pinion 64 to turn and drive the rack 62B, thereby moving the carriage 46B. Accordingly, by driving only the carriage 46A by means of the actuator 66, and providing coordination through the rack and pinion mechanism, both carriages 46A, 46B will move at the same time, either toward or away from each other. In particular, the arrangement shown in the drawings ensures that the carriages 46A, 46B always remain symmetrically disposed about the centre line of the lifting apparatus, which is at the plane of the centre plate 38.

FIG. 2 indicates, in broken lines, the manner in which the module 30 can support a lifting fork 20. The hook 26 of the fork 20 is hooked over the upper rail 42. The shank 24 extends down to rest against the lower connecting bar 40. More particularly, the hook 26 hooks onto the rail 42 between the plates 48 or 54 of one of the carriages 46A, 46B. A second fork 20 is mounted in similar fashion, with the corresponding hook 26 between the plates of the other carriage 46A, 46B.

It can thus be understood that movement of the carriages 46A, 46B controls the position of the respective forks 20 by pulling or pushing the forks 20 along the rail 42 and lower bar 40. Since the carriages 46A, 46B are coordinated to be positioned symmetrically about the plate 38, as has been described, the forks 20 are therefore also similarly constrained to be positioned symmetrically about the plate 38, particularly by choosing dimensions which cause the hooks 26 to be a snug fit between the plates 48, 54.

The result is an arrangement in which a relatively simple actuator arrangement, combined with the rack and pinion linkage, ensures that the load carried by the forks 20 will always be centred relative to the lifting apparatus 10, which results in safer handling. Furthermore, the position of the forks 20 can readily and quickly be altered by the machine operator, by providing an appropriate control for the actuator 66 within the cab of the apparatus, so that it is not necessary for the driver to leave the cab in order to adjust the separation of the forks 20.

FIGS. 6 to 10 show an alternative embodiment which can be mounted as a modification to the coupling 14 of the previous proposal.

This second embodiment can be briefly summarised by reference to FIG. 6. In this embodiment, a module 72 is fitted on top of the coupling 14 and includes carriages indicated generally at 74, and to be described in more detail, which include control portions 76 fitting over, and running along the upper bar 16. The control portions 76 entrap lifting forks 20, generally in the manner described above.

In more detail, FIG. 7 illustrates the module 72, cut away to reveal a plate 78 which includes a control portion 76 having an eye 80 for receiving the upper bar 16, a carriage arm 82 extending within the module housing 84, and a neck 86 connecting the control portion 76 and the carriage arm 82. Four plates 78 are provided, which each have the same profile except that only one plate 78A has an additional actuator arm 88 extending up from the neck 86 to reach over the upper surface of the housing 84. An eye 90 is formed near the end of the actuator arm 88.

The plates 78, 78A are paired and attached together to be parallel, by means of webs 92 (FIG. 8). FIG. 8 shows the carriage which includes the plate 78A. The other carriage does not have the actuator arm 88 on either plate 78.

At least one rail 94 is provided within the housing 84 to allow the two carriages to slide along the bar 16, with the carriage arms 82 sliding within the housing 84, along the rails 94.

Within the housing 84, as shown in FIG. 9, each carriage 74 carries a horizontal, straight rack 96, which both mesh with a common pinion 98, generally in the manner described above in relation to FIGS. 2 to 5. Consequently, movement of the carriages 93 is coordinated by the rack and pinion arrangement, to ensure that movement of one carriage 93 is accompanied by movement of the other and in particular, that the carriages 93 remain, at all times, symmetrically disposed about the centre line of the arrangement and thus of the lifting apparatus.

Above the housing 84, as can be seen from FIG. 10, a single hydraulic actuator 100 is provided, having a cylinder 102 attached to the housing 84, and a shaft 104 extending away from the cylinder 102 and secured to the actuator arm 88 of the plate 78A. The actuator 100 is a double acting actuator thus allowing the plate 78A to be pulled toward the cylinder 102, or pushed away from the cylinder 102. This creates movement in the corresponding carriage 93 and thus, by interaction through the rack and pinion mechanism, creates equivalent movement in the other carriage 93, so that operation of the single actuator 100 allows both carriages 93 to be moved simultaneously, while both also remain symmetrically disposed about the centre line.

In use, two lifting forks 20 are hung from the upper bar 16, with the hook 26 of each between the plates 78, 78A of a respective carriage 93. Thus, as the actuator 100 drives the carriages 93 along the bar 16, the lifting forks 20 are also moved. The separation of the forks 20 can thus be adjusted by hydraulic control from a convenient position, while it is ensured that the forks 20 remain symmetrically disposed about the centre line at all times. The load carried by the forks is thus centred, which results in safer handling.

In the examples described above, a single, linear, hydraulic actuator 66, 100 is used to create movement. It is envisaged that motive power could be provided in other ways. For example, it is envisaged that the pinion 64 could be directly driven by an appropriate motor, such as a hydraulic motor. In this example, the pinion 64 would be providing the dual functions of applying drive to the racks 62, and also coordinating movement of the two racks 62.

Alternative arrangements for providing coordination between the carriages are also envisaged. FIG. 11 shows an example applied to the second embodiment, in place of the racks 96 and pinion 98. In this example, two cables, wires, ropes, wire ropes or other flexible elongate articles 110 are used to connect the carriages 74. Pulley wheels 112 are provided at opposite ends of the module 72. Each cable 110 passes round one or other wheel 112. The ends of the cables 110 are connected to respective carriages 74. Consequently, if one of the carriages 74 moves toward the other carriage, or away from it, a respective one of the cables 110 will tighten and pull the other carriage to move it in the opposite direction. Thus, the cables 110 and wheels 112 serve to coordinate movement of the carriages 74 so that they remain symmetrically disposed about the centre line of the arrangement.

In this example, one of the carriages 74 may be driven by a single hydraulic actuator, such as the actuator 100. Alternatively, it may be possible to provide direct drive to one of the pulley wheels 112. If the elongate article 110 is in the form of a chain, pulley wheels 112 could be in the form of toothed wheels to provide secure engagement with the chain, thus improving the ability of the arrangement to be driven directly by means of the toothed wheel 112.

A similar arrangement of flexible members and pulleys can be used for coordination in a modified version of the first embodiment of the invention.

Many variations and modifications can be made to the apparatus described above, without departing from the scope of the present invention. In particular, many different shapes, forms, sizes and relative sizes of the various components could be devised. Other arrangements for coordinating the movement of the carriages could be devised, and other arrangements could be devised for transmitting movement from the carriages to the forks.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. An arrangement for controlling lifting forks in a mechanical lifting apparatus, comprising a slide arrangement on which the forks are supported, during use, and along which the forks may slide toward or away from each other, control members operable to move respective forks along the slide arrangement, and a linkage between the control members and which, in use, causes the movement of the control members to be coordinated in a predetermined fashion.

2. An arrangement according to claim 1, wherein the linkage causes the control members to move in opposite directions.

3. An arrangement according to claim 1, wherein the linkage causes the control members to remain symmetrically disposed about a fixed position.

4. An arrangement according to claim 3, wherein the fixed position is on the centre line of the lifting apparatus.

5. An arrangement according to claim 1, wherein the linkage includes toothed members which move as the control members move, and which mesh with a common rotatable member to provide coordination in the movement of the toothed members and thereby of the control members.

6. An arrangement according to claim 5, wherein the toothed members are racks which mesh with a common pinion wheel.

7. An arrangement according to claim 6, wherein a drive arrangement is provided for the common pinion wheel, thereby providing coordinated driven movement of the control members.

8. An arrangement according to claim 1, wherein the linkage includes at least one elongate flexible member connected at its ends to respective control members, and at least one pulley arrangement cooperating with the flexible member, so that when one of the control members is moved in at least one direction, the flexible member is caused to pull the other control member, to coordinate movement.

9. An arrangement according to claim 1, wherein an actuator is provided, operable to drive one of the control members.

10. An arrangement according to claim 1, wherein each control member includes two surfaces between which the respective fork is captive to move as the control member moves.
